(19) United States
(12) Patent Application Publication
(10) Pub. No.: US 2004/0079500 A1
(43) Pub. Date: Apr. 29, 2004

(54) Absorbent tissue layer

(75) Inventors: Anna Mansson, Molndal (SE); Magnus Falk, Onsala (SE); Anders Andersson, Stenungsund (SE); Inger Andersson, Lindome (SE)

Correspondence Address: YOUNG & THOMPSON, 745 SOUTH 23RD STREET 2ND FLOOR, ARLINGTON, VA, 22202

(73) Assignee: SCA HYGIENE PRODUCTS AB, GOTEBORG (SE)

(21) Appl. No.: 10/687,592

(22) Filed: Oct. 20, 2003

Related U.S. Application Data
(60) Provisional application No. 60/419,086, filed on Oct. 18, 2002.

(51) Int. Cl. D21H 27/00; B32B 1/08

(52) U.S. Cl. 162/109; 162/123; 162/117; 162/146; 428/34.2

(57) ABSTRACT

An absorbent tissue layer comprises at least one ply where the density of the layer is equal to or less than 130 kg/m³ and the elastic recovery value of the layer is greater than 90%, more preferably 95%, and most preferably 98%. The invention also relates to a product such as a roll or bundle of tissue layer where the elastic recovery value of the layer is greater than 90%, more preferably 95%, and most preferably 98%, and the density of the roll or the bundle is 200 to 300 kg/m³. The ratio between the density of the layer, when it has been separated from the roll or the bundle, and the density of the roll or the bundle is less than 0.65, and the density of the layer when separated from the roll or the bundle is 30 to 130 kg/m³.

### FIELD OF THE INVENTION

The present invention relates to an absorbent tissue layer and also a product with a tissue layer.

### BACKGROUND OF THE INVENTION

In the manufacture of tissue paper, it is desirable to produce a paper which inter alia is strong, has high bulk, is highly absorbent and is soft. Paper with high bulk gives a paper which is highly absorbent, and these properties are of value in tissue paper. However, high bulk leads to great volume, which is a disadvantage from the point of view of storage and transport. Tissue paper is a product often used at large-scale consumers, for example as hand-towel paper or for industrial cleaning. The paper is often converted in roll form. In the case of such use, it is of great interest not to have to change roll so often. Paper rolls many metres long are then necessary, and, when it is desirable at the same time to have a paper with high bulk, such rolls will take up a very great amount of space. This leads to the paper rolls occupying a great volume during storage, during transport and at the consumer's. These problems are solved by the invention.

### SUMMARY OF THE INVENTION

The invention relates to an absorbent tissue layer comprising at least one ply where the density of the layer is equal to or less than 130 kg/m³ and the elastic recovery value of the layer is greater than 90%, more preferably 95%, and most preferably 98%.

The invention also relates to a product such as a roll or bundle of tissue layer where the elastic recovery value of the layer is greater than 90%, more preferably 95%, and most preferably 98%, and the density of the roll or the bundle is 200 to 300 kg/m³ and also the ratio between the density of the layer, when it has been separated from the roll or the bundle, and the density of the roll or the bundle is less than 0.65, and the density of the layer when it has been separated from the roll or the bundle is 30 to 130 kg/m³.

By means of the invention, a paper or tissue layer is obtained which virtually recovers its bulk and thickness in the unrolled state after it has been pressed together on a roll. The tissue layer is rolled up on a core, is rolled into a roll without a core or is arranged in a bundle and compressed so that the paper, which has bulges, is pressed together. The material in the component plies recovers elastically after compression. By virtue of the elastic recovery effect, the layer virtually recovers its volume and bulk when unrolled from the roll or removed from the bundle. This results in volume-saving in the roll or the bundle while a paper which has great volume and high bulk during use is obtained. In spite of the high bulk of the paper in the unrolled state, high density on the roll or in the bundle is obtained.

### DESCRIPTION OF FIGURES

FIG. 1 shows diagrammatically an arrangement for compressing a tissue web with a rider roller and supporting rollers one and two.

FIG. 2 shows diagrammatically a cross section of part of a tissue layer according to an embodiment of the invention.

FIG. 3 shows an illustration of a TAD wire.

FIG. 4 shows a height profile of a TAD wire.

FIG. 5 shows the small diamonds roller pattern.

FIG. 6 shows an illustration of the small diamonds roller pattern.

FIG. 7 shows the accordion roller pattern.

FIG. 8 shows an illustration of the accordion roller pattern.

### DETAILED DESCRIPTION OF THE INVENTION

The invention will now be described in greater detail.

In order to manufacture a tissue layer, or a ply to be included in a layer, using a wet process, fibres are suspended in water. The resulting very thin stock is conveyed to a paper machine and is conveyed out onto a wire or between two wires. The stock is concentrated, and a wet web is then formed.

There are various ways of shaping and drying the wet web in a paper machine. In a conventional tissue machine, the paper web may, after it has been removed from the wire on which it has been formed, be pressed in order to remove water remaining in the paper web. The web can then be dried on a Yankee cylinder. The web is attached to the cylinder and dried on it and is then removed by means of a doctor, that is to say creping, which gives the material thickness and flexibility.

Another way of drying the wet web is Through-Air-Drying, or TAD. The web is dried completely or partly while it is supported by the wire which gives it its shape, and hot air is blown through the paper web. The wire may be, for example, an embossing wire or a patterned TAD wire. The TAD wire can have a distinct three-dimensional pattern which is transferred to the paper web before and during through-air-drying. Final drying of the paper web can take place on a heated cylinder, from which it can be removed with or without creping. In the case of such drying, the paper web is usually pressed against the heated cylinder when it is still supported by the wire.

Shaping and drying of the wet paper web can also be carried out by impulse-embossing. The wet paper web passes through a press roll nip comprising a rotatable roller which is heated and has a pattern of alternate raised and lowered portions intended to be pressed into the paper web against a counterstay. The paper web is heated rapidly and under high pressure. When the pressure is released, the heated water evaporates and expands rapidly, and the paper web is provided with a three-dimensional pattern. The paper web is preferably carried through the press roll nip by a compressible press felt. The roller is heated to a temperature which is sufficiently high to bring about drying of the paper web. Very rapid, intense and almost explosive steam generation takes place at the interface between the heated roller and the moist paper web, the steam generated carrying water away with it on its way through the paper web. This is described in WO 99/34055.

The shape should be supported and maintained throughout drying in the paper machine but at least up to at least 60-70% dry content. A layer with bulges which expand after compression is then obtained. In other words, the layer will recover elastically to virtually original thickness after release after compression.

The ply has bulges protruding from its plane. It will recover elastically after compression owing to the fact that it has a shape memory, that is to say they return to essentially the original shape after compression. The shape memory is brought about by virtue of the fact that the bulges are created when the ply is wet, that is to say has less than 25% dry content, and the shape is maintained during drying.

By virtue of the abovementioned shaping and drying techniques, the paper web is given a special shape, a pattern. This pattern is in the form of bulges which have been shaped in the depressions of the wire which are present in the weave of the wire or patterns on a roller if one is used.

The layer according to the invention is designed with a pattern of bulges which give the layer its good properties. The shaping of bulges can take place directly on a wire on which the wet paper web is formed or onto which it is conveyed; alternatively, the patterning can take place on another wire onto which the wet paper web is transferred. The wire is shaped so as to give the layer the desired pattern, and the paper web is dried in contact with this wire in order to lock the structure in the paper or the layer. The layer is preferably shaped when it is wet.

The tissue layer can be creped in a conventional manner and if so very little, after manufacture as above, but it is preferable not to crepe the layer.

Subsequent drying can take place against the roller or in a downstream drying unit.

The tissue layer normally comprises mainly natural ligno-cellulose wood fibres. All sorts of paper pulp, with different types of fibre, can be used in the manufacture of the layer. The layer can also comprise synthetic or regenerated fibres. Examples of synthetic fibres are polyester, polypropylene, polyamide or polyvinyl chloride. Regenerated fibres are, for example, viscose, lyocell and acetate. It is also possible to use plant fibres, and examples are flax, abaca and cotton.

The suspension used for manufacturing a wet paper web can include wet-strength agents in order that the tissue material will have high wet strength and wet stability. Conventional wet-strength agents can be used, and polyamide-polyamine-epichlorhydrin resins, cross-linked polymeric formaldehyde resins and aldehyde derivatives of polyamide resins may be mentioned as examples. Wet-strength agents are added in a quantity of up to 30 g/kg finished product, preferably up to 15 g/kg finished product.

Wet stability is brought about in layers and plies according to the invention when these have been manufactured with wet-strength agents.

The thickness of plies or layers is measured according to SCAN-P 47:83 with the difference that the measurement is performed on one ply or layer instead of eight. FIG. 2 shows a cross-sectional view of part of a layer 21 constructed of a single ply 22 with a pattern of cup-shaped bulges 23. The layer has the thickness D, measured between the top point of the bulge and the base plane 24. The density of a ply/layer is determined from thickness and grammage: density=grammage/thickness. To determine the density of a product, the volume of the product is determined from its geometrical dimensions, and the density is calculated from volume and weight.

To determine the elastic recovery value, a bundle of at least 10 plies/layers is pressed. The bundle is compressed to a density of 200 kg/m³ (that is to say if the grammage of the ply/layer is g (g/m²) , the thickness of the bundle will be n*g/200 (mm), where n is the number of plies), is held thus for 10 minutes and is then released. Compression can be carried out between two parallel plates which can be positioned using, for example, screws or in a tensile testing machine. In normal cases, the bundle will not be conditioned. The thickness of a ply/layer is measured on a conditioned sample uncompressed (D₀) and removed from the compressed bundle (Dₖ). Elastic recovery is stated as Dₖ/D₀.

Wet strength is measured according to SCAN-P 58:56 as the tensile strength on breaking of a strip of a width of 50 mm which has been soaked in water for 15 seconds before testing. A geometrical mean value is calculated from wet strength measured in the machine direction and in the cross direction.

Dry strength is measured according to SCAN-P 44:81. Relative wet strength is calculated as the ratio between the geometrical mean value of wet strength and the geometrical mean value of dry strength and is stated in %.

A product is defined as a wet-strength product when the relative wet strength is more than 15%.

Wet stability is measured using a thickness gauge which meets the requirements of SCAN-P 47:83. Measurement is performed on a dry ply which is then soaked with water, after which thickness measurement is performed on the wet ply as well. Bulk (wet or dry) is calculated as thickness/conditioned grammage.

Unless otherwise stated, testing is carried out on conditioned samples. Conditioning takes place according to SCAN-P 2:75, 23° C., 50% RH (relative humidity) to equilibrium, normally for more than 24 hours.

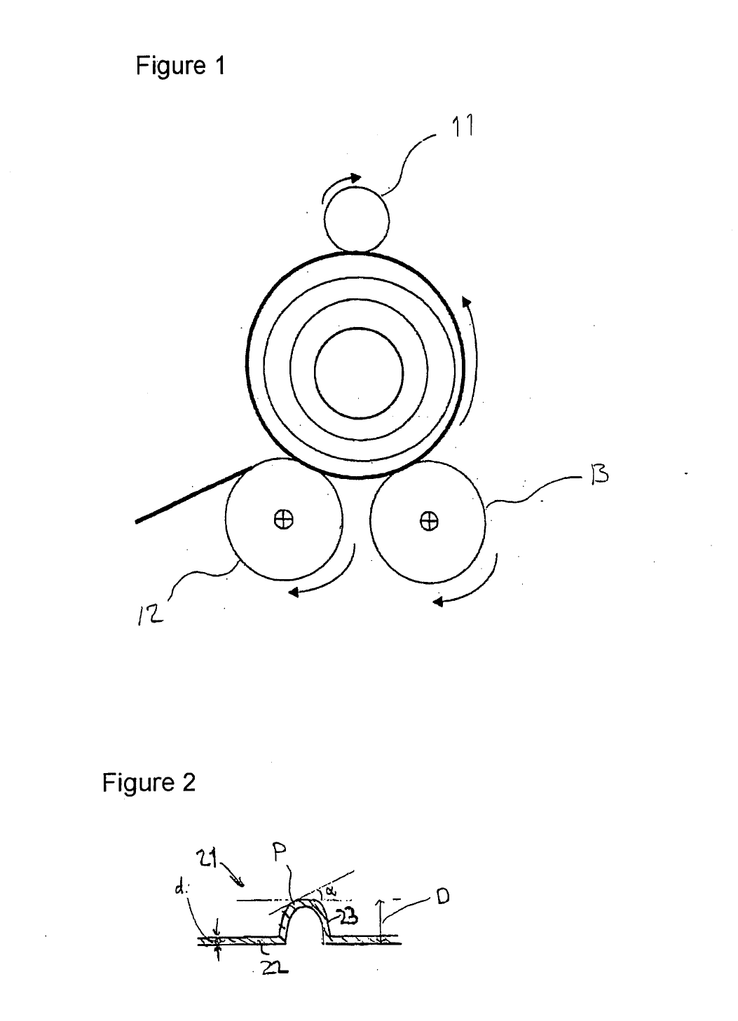

The rolling-up is carried out in a conventional way. In order to produce paper rolls with high density and hard rolls, use is made of high tension of the paper web or a rider roller in order to increase the pressure during rolling-up or rollers with increasing speed for stretching. Supporting-roller rolling with a separately driven rider roller 11 (see FIG. 1), where the compression can be regulated by both roller pressure and web tension, is preferred. The web tension is regulated by speed difference between unrolling and supporting rollers 12, 13 as well as between supporting rollers 12, 13 and rider roller 11. Preferred values are 500-3000 N/m rider-roller pressure and 1-4% overspeed for supporting roller two 13 and 2-6% overspeed for the rider roller 11 relative to the first supporting roller 12.

For bundled products, vacuum-packing using conventional methods is preferred.

The invention also relates to a product, such as a roll or bundle with a compressed tissue layer which recovers elastically and combines the advantages of high bulk in use and low bulk beforehand. This means that the density in the roll or the bundle is higher than the density in the layer when it has been separated from the product. In other words, higher bulk is obtained in the separated layer.

Here, the density of the roll or the bundle means the total density (weight/volume) of the layer in the roll or the bundle. Rolls can sometimes have a core on which the tissue layer is rolled up, and such a core is, for example, not included when the density on the roll is measured.

The product is made from tissue manufactured by, for example, TAD (through-air-drying) or an impulse-embossing technique, a material with a high degree of elastic recovery being obtained.

The layer expands when it is removed from the product, that is to say when the pressure on the layer is released. The fact that the layer recovers elastically so much that the ratio between the density of the layer when it has been separated from the product and the density of the product is less than 0.65, that the density of the layer when it has been separated from the roll or the bundle is 30 to 130 kg/m³, and that the density of the roll or the bundle is 200 to 300 kg/m³ is due to the design of the layer. The elastic recovery is brought about by the shape memory of the layer, which is a result of the wet-shaping of the layer. The shape memory is best when the layer has a dry content of at least 93-94%, preferably 96%, and most preferably 98%, in terms of the weight of the layer.

The low density of the layer in the separated state leads to the layer having a high bulk. A high bulk is important when the tissue layer is used, because inter alia it provides high absorption, while low bulk in the product is of interest because it then takes up less space.

The layer can consist of one or more plies. A laminated layer consists of at least two tissue plies, and these are joined either by adhesive means or mechanically.

The paper or the layer is used for wiping up, for example, liquid and dirt. Liquid will be absorbed in an advantageous way when the layer has a high bulk. A high bulk means that the fibres are relatively sparse or that there are large cavities, which means that a large quantity of liquid can be absorbed.

A high bulk also provides a pleasant feel for the user, and the layer feels like it has more substance for the same grammage. High bulk can be brought about by using material according to the present invention.

In order to produce a tissue layer according to the invention, certain dimensions of the unit providing the texture, that is to say the roller pattern or the TAD wire, are required. The height of the pattern should not be greater than 300 μm, more preferably 400 μm, and most preferably 800 μm, that is to say the thickness D of the layer is to be greater than 300 μm. Furthermore, the bulges should not be spread too sparsely. A spacing between the tops of the bulges of less than 4 mm, more preferably less than 2 mm, and most preferably less than 1 mm, is preferred.

The bulges have a cup shape with steep walls. Preferably at least 50%, more preferably 70%, and most preferably 90%, of the walls of the bulges have an inclination α greater than 45° in relation to the base plane of the layer. The inclination α at a point on a bulge consists of the angle formed between the tangent and a plane parallel to the base plane of the layer, as illustrated in FIG. 2 for the point P.

In order to provide the necessary elastic recovery, the pattern height should be greater than the thickness of the ply.

It is also preferable for the material to have a mechanical stability which supports elastic recovery. Mechanical stability can be brought about by the same means as are normally used to influence the strength, that is to say, for example, beating and strength-increasing chemicals. The necessary mechanical stability is also favoured by pressing and low creping, which means that uncreped TAD and impulse-embossing are preferred techniques.

The paper or the layer should have a dry content of at least 93-94%, or preferably 96%, and most preferably at least 98%, in terms of the total weight of the layer, in order for the shape of the paper to be maintained. At higher dry content values, the elastic recovery is stronger.

According to the invention, the absorbent tissue layer can be a wet strength tissue layer, that is to say the relative wet strength is more than 15%.

The tissue layer can also be wet-stable, that is to say the wet density can be up to 20%. The grammage per ply in the layer is 10-60 g/m², and the grammage of the layer is 18-400 g/m².

The following examples are provided for the purpose of illustration and are not to be construed as limiting the scope of the invention of the application.

### Example 1

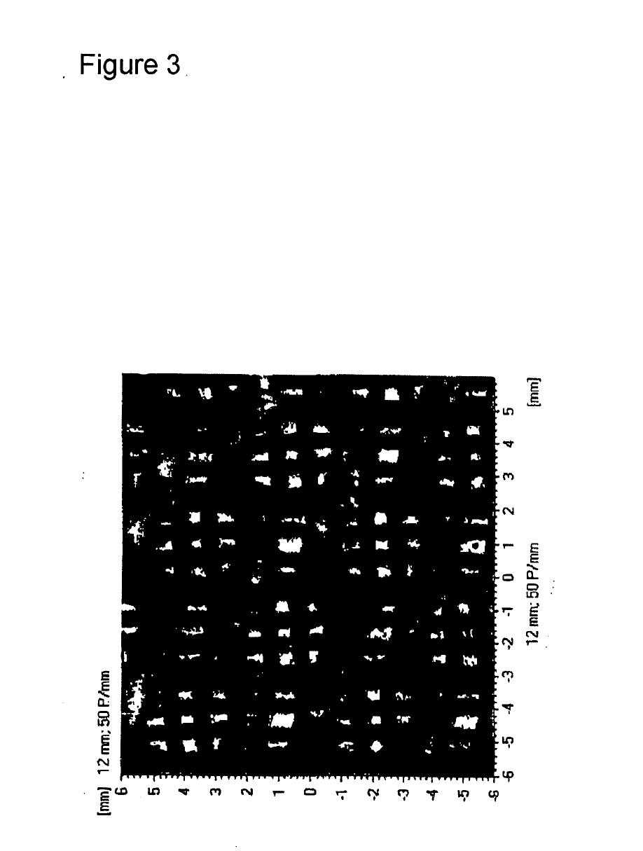

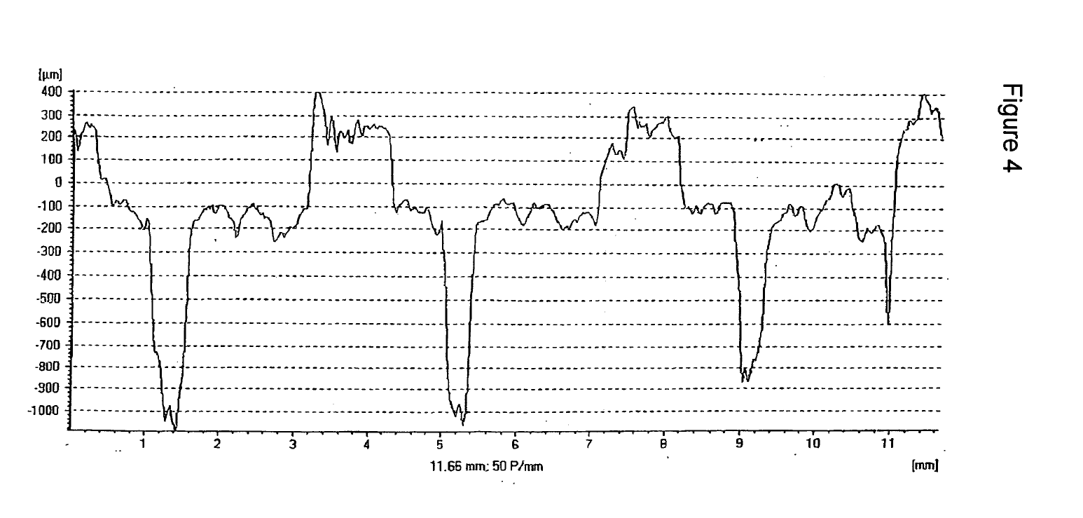

A material was manufactured using a TAD technique without creping. The TAD wire is described in PCT application WO 00/63489 and is reproduced in FIG. 3. The TAD wire has a height profile as shown in FIG. 4. The three deep troughs of the height profile occur when the gauge sees through the structure. The wire has a three-dimensional pattern comprising the characteristics necessary for it to be possible for bulges to be formed on a wet paper web if a sufficiently great low pressure generated by means of vacuum is used or if an air flow of sufficiently high pressure is blown through the paper web and the patterned wire. The TAD wire gives the paper a pronounced texture and high bulk. The height of the pattern is roughly 600 μm. The spacing between the tops is roughly 2.0 mm. The raw material was 100% woodfree recycled fibre, 75P2D from SCA UK Prudhoe mill. The material was calendered to a thickness of roughly 664 μm.

Material data:

Number of plies: 1

Grammage: 39.3 g/m²

Strength MD: 444 N/m

Strength CD: 273 N/m

Strain MD: 11.0%

Thickness: 664 μm

Elastic recovery value: 90% (600 μm)

Wet thickness: 527 μm

Density: 59 kg/m³

Dry content: 98%

The material was brought to a high dry content (98%) by drying in a desiccator over silica gel. A bundle was then compressed to a density of 220 kg/m³ and was kept in this state for 13 days, after which it was separated, and the thickness of the separated plies was measured again. The material then had the following values:

Thickness: 598 μm

Elastic recovery value: 90%

Wet bulk: 13.4%

Density: 66 kg/m³

### Example 2

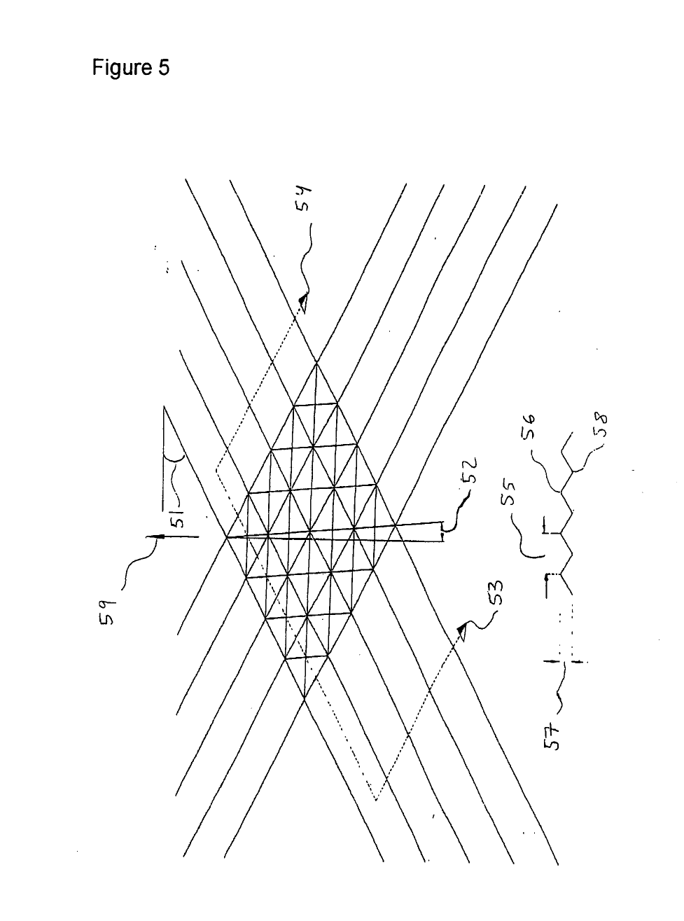

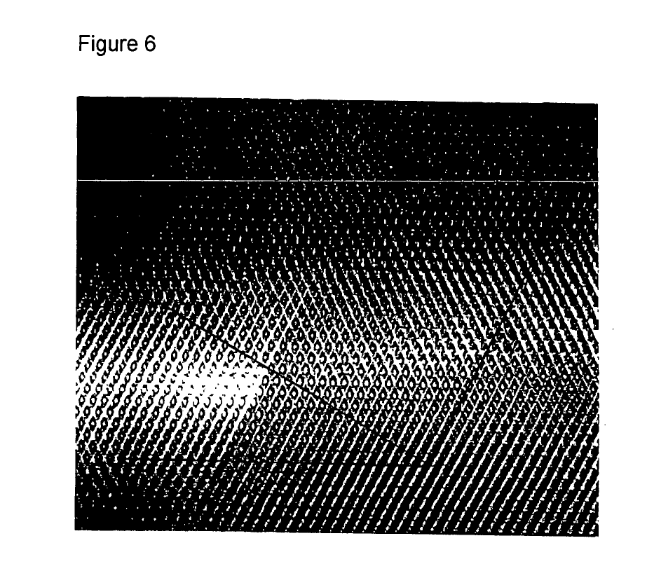

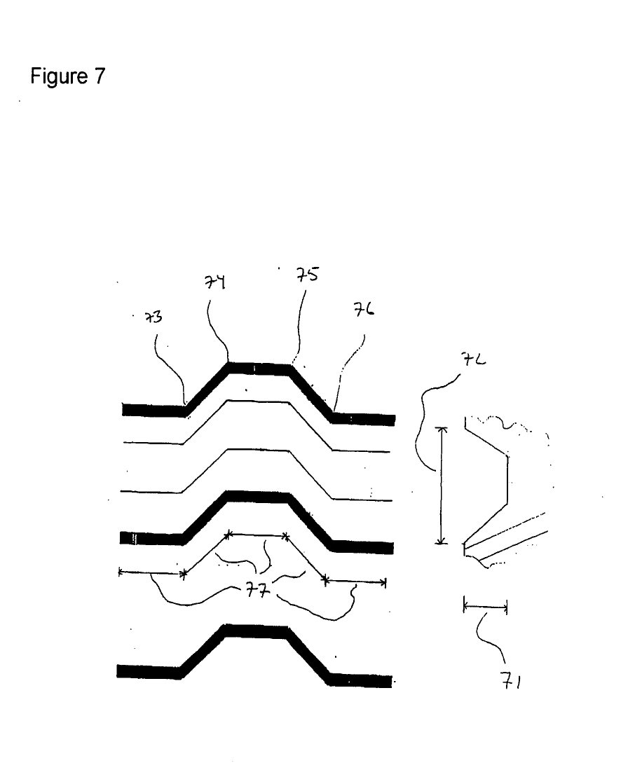

A material was manufactured using an impulse-embossing technique. The pattern was small diamonds, which gives the paper a pronounced texture and high bulk. This is illustrated in FIGS. 5 and 6. The pattern in FIG. 5 had the following proportions: the angle 51 was 27.5°, and the angle 52 was 5°. A section between 53 and 54 shows that the height 57 was 520 μm and the spacing 55 between two tops 56 was 1.667 mm, that is to say the spacing between a top 56 and a trough 58 was 0.83 mm. The arrow 59 shows the machine direction. The material was calendered to a thickness of roughly 500 μm. The raw material was 100% sulphate pulp long fibre.

Material data:

Number of plies: 1

Grammage: 22.9 g/m²

Strength MD: 173 N/m

Strength CD: 106 N/m

Strain MD: 9.2%

Thickness: 500 μm

Elastic recovery value: 100%

Wet thickness: 198 μm

Density: 46 kg/m³

Dry content: 98%

The material was brought to a high dry content (98%) by drying in a desiccator over silica gel. A bundle was then compressed to a density of 270 kg/m³ and was kept in this state for 13 days, after which it was separated, and the thickness of the separated plies was measured again. The material then had the following values:

Thickness: 510 μm

Density: 45 kg/m³

### EXAMPLE 3

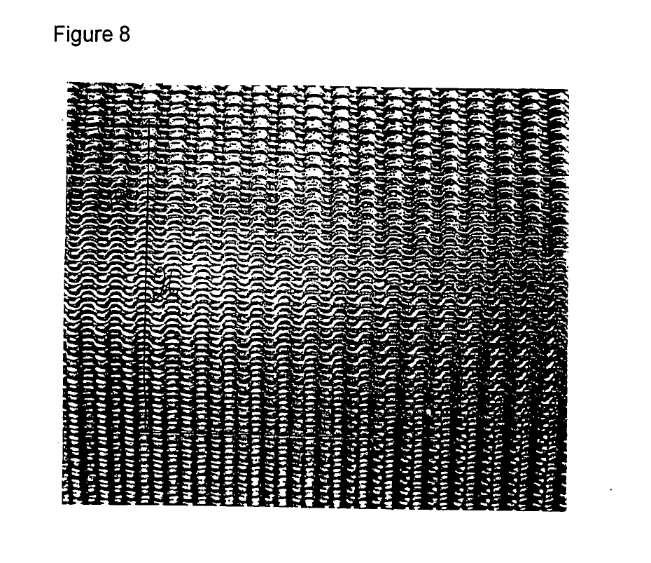

A material was manufactured using an impulse-embossing technique. The roller pattern was accordion, which gives the paper a pronounced texture and high bulk (see FIGS. 7 and 8). The pattern in FIG. 7 is seen from above and also shows a section where the height 71 was 900 μm and the spacing 72 was 2.83 mm. The angles 73-76 were all 45°. The spacing 77 was 2.00 mm. The material was calendered to a thickness of roughly 600 μm. The raw material was 100 LF sa.

Material data:

Number of plies: 1

Grammage: 20.5 g/m²

Strength MD: 152 N/m

Strength CD: 96 N/m

Strain MD: 12.4%

Thickness: 580 μm

Elastic recovery value: 95%

Wet thickness: 255 μm

Density: 35 kg/m³

Dry content: 98%

The material was brought to a high dry content (98%) by drying in a desiccator over silica gel. A bundle was then compressed to a density of 220 kg/m³ and was kept in this state for 13 days, after which it was separated, and the thickness of the separated plies was measured again. The material then had the following values:

Thickness: 520 μm

Density: 39 kg/m³

1. Absorbent tissue layer comprising at least one ply, wherein the layer has a density equal to or less than 130 kg/m³ and an elastic recovery value greater than 90%.

2. The absorbent tissue layer according to claim 1, wherein the tissue layer is provided with a pattern of bulges, which bulges deviate from their base plane by more than 300 μm.

3. The absorbent tissue layer according to claim 2, wherein the tops of the bulges have a mutual spacing of less than 4 mm.

4. The absorbent tissue layer according to claim 2, wherein the deviation of the bulges after elastic recovery is greater than the thickness of the ply and the bulges are cup-shaped.

5. The absorbent tissue layer according to claim 2, wherein at least 50% of the walls of the bulges have an inclination (α) greater than 45° in relation to the plane of the layer.

6. The absorbent tissue layer according to claim 1, wherein the layer has a dry content of at least 93-94% in terms of the weight of the layer.

7. The absorbent tissue layer according to claim 1, wherein the layer comprises only cellulose fibres.

8. The absorbent tissue layer according to claim 1, wherein the layer comprises synthetic thermoplastic fibres.

9. The absorbent tissue layer according to claim 1, wherein the layer comprises regenerated cellulose fibres.

10. The absorbent tissue layer according to claim 1, wherein the layer is a wet-strength layer having a relative wet strength of more than 15%.

11. The absorbent tissue layer according to claim 1, wherein the layer is wet-stable.

12. The absorbent tissue layer according to claim 1, wherein the layer is wet-shaped.

13. The absorbent tissue layer according to claim 1, wherein the grammage per ply is 10-60 g/m² and the grammage of the layer is 18-400 g/m².

14. The absorbent tissue layer according to claim 2, wherein the elastic recovery value is greater than or equal to 95%; the bulges deviate from their base plane by 400 μm or more; the tops of the bulges have a mutual spacing of less than 2 mm; at least 70% of the bulges have an inclination greater than 45° in relation to the plane of the layer; and the layer has a dry content of at least 96% in terms of the weight of the layer.

15. The absorbent tissue layer according to claim 2, wherein the elastic recovery value is greater than or equal to 98%; the bulges deviate from their base plane by 800 μm or more; the tops of the bulges have a mutual spacing of less than 1 mm; at least 90% of the bulges have an inclination greater than 45° in relation to the plane of the layer; and the layer has a dry content of at least 98% in terms of the weight of the layer.

16. Product comprising a roll or bundle of tissue layer, wherein the layer has an elastic recovery value greater than 90% and the roll or bundle has a density of 200 to 300 kg/M³.

17. The product according to claim 16, wherein the ratio between the density of the layer, when the layer has been separated from the roll or the bundle, and the density of the roll or the bundle is less than 0.65, and the density of the layer when separated from the roll or the bundle is 30 to 130 kg/m³.

18. The product according to claim 16, wherein the layer has a dry content of at least 93-94% in terms of the weight of the layer.

19. The product according to claim 16, wherein the elastic recovery value is greater than or equal to 95%, and the layer has a dry content of at least 96% in terms of the weight of the layer.

20. The product according to claim 16, wherein the layer has a dry content of at least 98% in terms of the weight of the layer.
